(19) United States
(12) Patent Application Publication
(10) Pub. No.: US 2005/0175777 A1
(43) Pub. Date: Aug. 11, 2005

(54) Method of providing a substrate surface with a patterned layer

(75) Inventors: Eliav Itzhak Haskal, Eindhoven (NL); Ivo Godfried Jozef Camps, Eindhoven (NL); Paulus Cornelis Duineveld, Eindhoven (NL); Anouk Maria Van Graven-Claassen, Eindhoven (NL); Antonius Johannes Maria Van Den Biggelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKILIJKE PHILLIPS ELECTRONICS N.V.

(21) Appl. No.: 10/515,685

(22) PCT Filed: May 8, 2003
(86) PCT No.: PCT/IB03/01930

(30) Foreign Application Priority Data
May 27, 2002 (EP) 02077058.2

(51) Int. Cl. B05D 1/36; B05D 5/00

(52) U.S. Cl. 427/258

(57) ABSTRACT

A method of manufacturing a patterned layer (4) on a substrate comprises providing a substrate surface (2) with a dam structure (6) partitioning the substrate surface into a plurality of compartments for containing fluid from which regions of the patterned layer are obtainable, filling, using a west deposition method, compartments with volumes of fluid and then obtaining from the volumes of fluid regions of the patterned layer. In order to obtain a patterned layer which has a relatively large thickness and a good uniformity in thickness, the filling and obtaining is done in several passes, each pass comprising filling a selection of compartments with fluid having a volume larger than the volume of the compartment and obtaining the corresponding regions therefrom, taking care in no selection two compartments which are nearest-neighbor of each other are included.

The invention relates to a method of providing, using a wet deposition method, a substrate surface with a patterned layer comprising a plurality of regions arranged mutually adjacent and spaced in accordance with a desired pattern.

Patterned layers comprising a plurality of regions arranged mutually adjacent and spaced in accordance with a desired pattern and methods to provide such layers on substrate surfaces are well known and are used in many industries, the graphics and printing industry being obvious examples. Also in the electronics industries such layers are used. Typically, in many cases such patterned layers are thin, say less than 100 μm, and are part of devices comprising a stack of such layers. Examples include semiconductor and display devices such as electroluminescent devices. As is well kown, such layers may be manufactured using wet deposition methods, such as printing and coating methods, in which typically a fluid, from which a region of the layer is obtainable, is deposited on desired locations of the substrate surface and then the fluid so deposited is converted into region of the layer. Within the art of wet depositing such patterned layers, there is a constant drive to provide methods which are cost-effective and simple and allow high patterning accuracy and a good thickness uniformity of layer thickness. To achieve patterning accuracy and a good thickness uniformity it has been proposed to use dam structures which check the flow of fluid from which a region of the patterned layer is to be obtained.

WO 01/41229 describes a method of providing a patterned layer using a dam structure as part of a method of manufacturing an electroluminescent device. The patterned layer is, for example, a polymeric layer which is provided by means of ink jet printing using a dam structure in the form of a relief pattern. Because the fluid from which the polymeric layer is obtained contains very little, only a few percent by weight, polymeric material in order for the fluid to be ink-jet printable and the height of the dam structure which can be used is limited, the thickness of the layer which can be deposited is relatively small.

It is an object of the invention, inter alia, to provide a method of providing a substrate surface with a layer comprising a plurality of regions arranged mutually adjacent and spaced in accordance with a pattern using a wet deposition method. In particular, an object of the invention is to provide a method which allows is suitable for a large range of fluids, in particular for fluids containing only small amounts of the material from which a region of the layer is to be formed. More in particular, it is an object to provide a method which allows relatively thick patterned layers to be deposited.

This object is achieved using a method of providing, using a wet deposition method, a substrate surface with a patterned layer comprising a plurality of regions arranged mutually adjacent and spaced in accordance with a desired pattern, the method comprising: providing a substrate surface with a dam structure in accordance with a pattern partitioning the substrate surface into a plurality of substrate regions to be covered by regions of the layer, the plurality of substrate regions and the dam structure together forming a plurality of compartments for containing volumes of fluid from which the plurality of regions is obtainable;
making, among the plurality of compartments, a selection of compartments such that none of the compartments within the selection is a nearest neighbor of another compartment within the selection;
filling, using the wet deposition method, each of the compartments of the selection with a volume of a fluid from which a region of the layer is obtainable in a quantity which is larger than the volume of the corresponding compartment;
obtaining from the volumes of fluid contained in the compartments the corresponding region of the layer and/or reducing the volumes of fluid contained in the compartments to a volume less than the volume of the corresponding compartments; if there exist, among the plurality of compartments, compartments which have not yet been selected, making, among the plurality of compartments, a selection of compartments including compartments which have not yet been selected, the selection being such that none of the compartments within the selection is a nearest neighbor of another and then going back to step c);
if there exists, among the plurality of compartments, a compartment which contains fluid, obtaining the corresponding region from the volume of fluid contained in such compartment.

In the method in accordance with the invention, it is essential that a compartment is filled with a quantity of fluid which is larger than the volume of that compartment and compartments which are nearest neighbors of each other are not filled with such quantity of fluid at the same time. In this context at the same time means within a single pass, a pass comprising the steps of filling a number of compartments and obtaining the corresponding regions from the volumes of fluid contained in the filled compartments (hereinabove itemized as steps “c)” and “d)” respectively).

The inventors have observed that for a certain combination of fluid and dam structure only a relatively small layer thicknesses can be manufactured reliably. If the deposition of a relatively thick patterned layer is attempted, the patterned layer both within and between regions is very non-uniform in thickness. Large variations in thickness are observed on a scale encompassing many regions. The inventors have had the insight that the non-uniformity in layer thickness may be caused by the fact that in the process of manufacturing the regions, the volumes of fluid contained in nearest-neighbors compartments, instead of remaining separate, touch each other and, because of the tendency to minimize surface tension, merge into single volume of fluid. Merged volumes of fluid produce quite different regions compared to separate volumes of fluid of the same volume.

In order to prevent the unwanted merger of nearest-neighbor volumes of fluid, the method in accordance with the invention does not fill all the compartments which need filling in a single pass, but uses a plurality of passes to fill all the compartments. Within each pass a selection is made among the plurality of compartments, the selection being such that none of the compartments within the selection are nearest-neighbors of one and another (this is expressed in step “b)” for the first pass and step “e)” for subsequent passes). Evidently, for the method to end, the selection should include compartments which have not been filled in any previous pass. The compartments in the selection are then filled with fluid (step “c)”). In order to prevent any merging of such volumes of fluid with any volume of fluid deposited in a subsequent pass, the volumes of fluid are converted into the corresponding region or at least the volume is reduced to a level that no merging can occur (step “d)”). Typically, no merging occurs if the volume is less than the volume of the compartment in which the fluid is contained.

By filling in separate passes, the method in accordance with the invention allows the compartments to contain more fluid thus allowing a relatively thick patterned layer having a good thickness uniformity to be obtained at a high resolution.

The dam structure may be left in position after the pattern is formed or removed after the patterned layer is formed. Removal is preferred if the substrate carrying the patterned layer is to be subjected to further processing and the subsequent processing is adversely affected by the dam structure. On the other hand, if the removal of the dam structure damages the patterned layer or the substrate it may be prudent to leave the dam structure in position. The latter option is in general preferable if the patterned layer is an organic patterned layer, in particular if the dam structure is a photoresist relief pattern.

The method may be used to provide a layer which is homogeneous in terms of composition, that is a patterned layer of which the plurality of regions are all made of the same material. However, the method is particularly suitable for patterned layers comprising regions which are formed from different materials providing regions having different properties such as different optical, electrical, electro-optical or magnetic properties.

The method in accordance with the invention is particularly suitable if the patterned layer is formed from polymeric material. Polymeric materials generally have a high viscosity. In order to obtain a fluid containing polymeric material which has a viscosity compatible which conventional printing methods such as ink jet printing very dilute fluids need to be used. Accordingly, to obtain a patterned layer more fluid is needed and consequently the risk of volumes of fluid contained in nearest neighbor compartments particularly large.

The dam structure may be any structure which is suitable for checking the volume of fluid contained in a compartment. In order to obtain regions from the volumes which are uniform in thickness, the shape and material of the dam structure should be selected in accordance with the fluid and the quantity of the fluid to be deposited. The volume of fluid deposited in the compartment exceeds the volume of the compartment which is possible without flooding if the interaction between fluid, substrate surface and dam structure is mainly determined by surface tension (and thus wettability being a relevant parameter) as opposed to gravity.

A particular embodiment of a dam structure is a molecular monolayer. Such molecular monolayers are well known as such. The monolayer may be hydrophilic if an apolar fluid is to be deposited or hydrophobic if a polar fluid is to be deposited. Dam structures of monolayers have the advantage of being low in height and relatively easy to remove after the regions have been removed without damaging the regions.

Alternatively, the dam structure may be a relief pattern. Such patterns may of advantage when a large quantity of fluid is to be contained. Although the relief pattern may be formed of any suitable material which is degraded in contact with the fluid, for example inorganic material such as a metal, a ceramic material, oxidic material, glass and the like, preferable a photoresist pattern is used as a photoresist pattern is easy to manufacture.

The pattern in which the dam structure is provided is obviously first of all determined by the desired pattern of the patterned layer, as region can only form in substrate regions which are exposed by the dam structure. Suitable dam structure patterns include rectangular and hexagonal patterns or a uniform layer in which cylindrical (circular cylindrical, frusto-conical) compartments are cut out. The method is particularly suitable if the dam structure comprises a plurality of strips which are arranged mutually parallel and spaced on the substrate. Using such a dam structure allows all compartments to be filled a fluid in a minimum number of passes, because each compartment has at most two nearest neighbors.

Filling the compartments may be done using any suitable wet deposition method which is capable of individually filling the compartments with fluid such as transfer silk screen or off screen printing methods. For high resolution, dispensing or ink jet printing is a preferred method, in particular a single nozzle or multi-nozzle method. In a preferred embodiment of the method in accordance with the invention, a compartment is filled with a quantity of fluid sufficient to wet more than half the surface area of the dam structure section forming the compartment.

The method is of particular use in the manufacture of electroluminescent devices such as polymer electroluminescent devices.

These and other aspects of the invention will be elucidated further with respect to the drawings and embodiments described hereinbelow.

In the drawings:

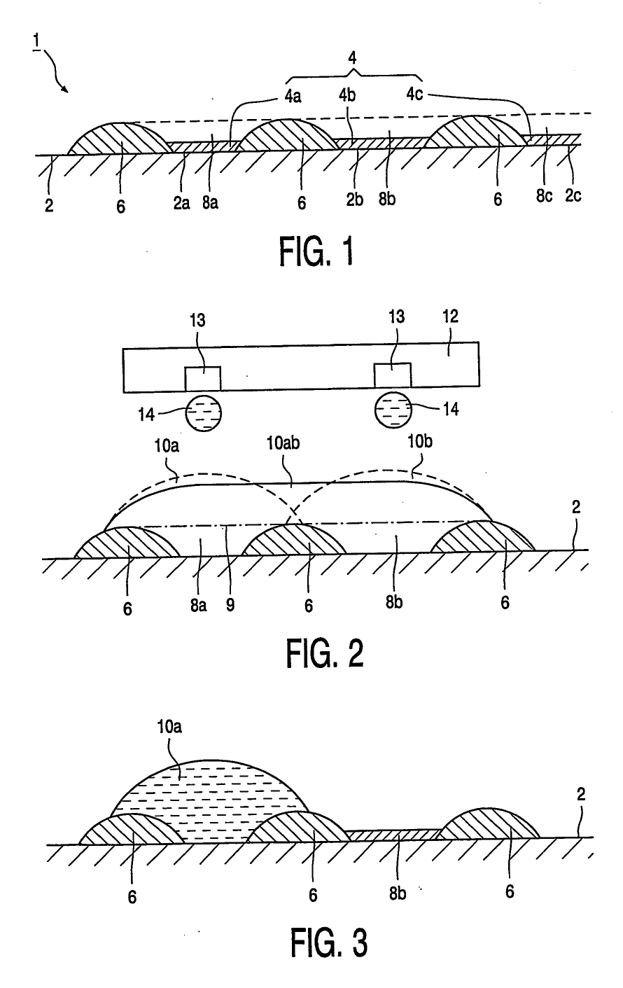

FIG. 1 shows, schematically, a cross-sectional view of a substrate surface provided with a patterned layer;

FIG. 2 shows, schematically, a cross-sectional view of a stage of a prior art method;

FIG. 3 shows, schematically, a cross-sectional view of a stage of a method in accordance with the invention;

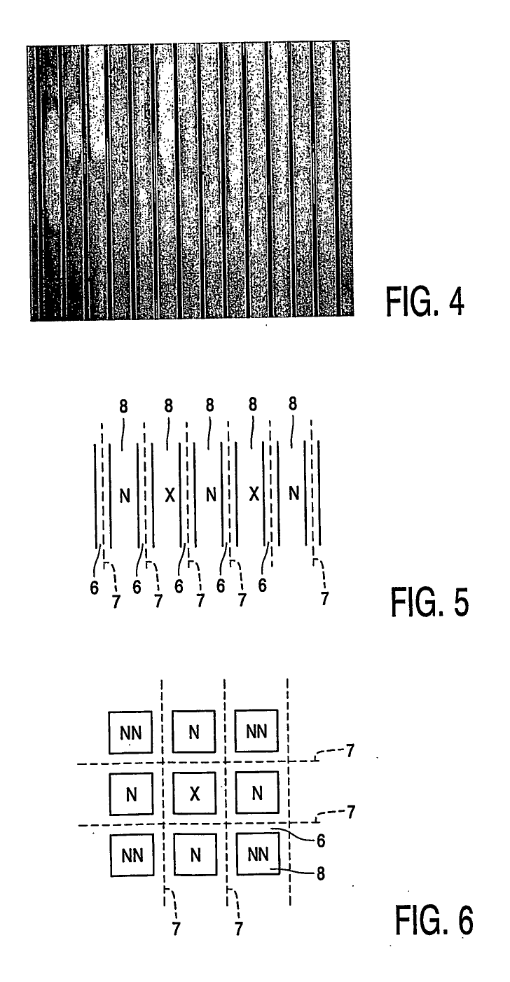

FIG. 4 shows a microscopic photograph of a top view of a substrate surface provided with a patterned layer using a prior art method;

FIG. 5 shows, schematically, in a top view, a pattern of a first dam structure;

FIG. 6 shows, schematically, in a top view, a pattern of a second dam structure;

FIG. 7 shows, schematically, in a top view, a pattern of a third dam structure;

FIG. 1 shows, schematically, a cross-sectional view of a substrate surface provided with a patterned layer.

The structure 1 shown has a substrate surface 2 which is provided with a patterned layer 4 comprising a plurality of regions, the regions 4a, 4b and 4c being shown. The regions 4a, 4b and 4c are arranged mutually adjacent and spaced in accordance with a desired pattern. Being a cross-section, the pattern is not entirely completely discernible from FIG. 1. FIGS. 5, 6 and 7 show various examples of patterns of which FIG. 1 could be a cross-sectional view. The regions 4a, 4b and 4c cover corresponding substrate regions 2a, 2b and 2c, the substrate regions being obtained from the partitioning of the substrate surface 2 by the dam structure 6. The dam structure 6 and substrate regions 2a, 2b and 2c form a plurality of compartments 8a, 8b and 8c which each are suitable for containing a volume of fluid from which a corresponding region 4a, 4b or 4c is obtainable.

FIG. 2 shows, schematically, a cross-sectional view of a stage of a prior art method to manufacture the layer of FIG. 1.

FIG. 2 illustrates the problem associated with the prior method. After having provided the substrate surface 2 with the dam structure 6, an inkjet head 12 comprising multiple nozzles 13 (use of a single nozzle leads to the same result) is positioned over the compartments 8a and 8b. Droplets 14 are then deposited in the respective compartments 8a and 8b to form volumes of liquid 10a and 10b. The interrupted line 9 indicates the top surface of the compartments 8a and 8b. The line 9 corresponds to the maximum level to which the compartment 8a or 8b could be filled before flooding would occur in the case gravity—as opposed to surface tension—is the decisive factor in deciding whether or not flooding occurs. In the context of the present invention, the volume enclosed by a line 9, the dam structure and the substrate surface is considered to be the volume of a compartment.

The methods which are the subject of the present invention are those in which surface tension as opposed to gravity is the dominant force determining the interaction of fluid, dam structure and substrate surface. The surface tension dominated regime applies when the dam structure and the space between the dam structure is small.

In a surface tension dominated regime the amount of fluid which can be accommodated by a, more specifically an isolated, compartment before flooding occurs is in general much larger than the volume of that compartment, such amount of fluid in the context of the present invention being referred to as the capacity of a compartment.

Thus as is clear from the volumes of liquid 10a and 10b deposited in the compartments 8a and 8b compared to the respective volumes of those compartments, the method of which a stage is shown in FIG. 2 is a method operated in the surface tension dominated regime. However, while being less than the capacity of the compartments 8a and 8b, the amount of fluid deposited therein is so large that the fluid boundaries of the volumes 10a and 10b would not only touch but even overlap each other at the middle section of the dam structure. As a result, in order to minimize surface free energy, the volumes 10a and 10b merge to form a single volume 10ab. As in a surface tension dominated regime generally the formation of layers from such volumes of fluid is determined by the interaction of fluid, specific dam structure and substrate surface, layer formation from of a merged volumes is different from layer formation in volumes of liquid which have not been merged. In fact, examples to be described hereinbelow illustrate that differences in layer formation have a dramatic effect on uniformity on layer thickness.

After having elucidated the problem associated with the prior art methods, the invention also provides a solution for this problem by requiring that the patterned layers be formed in multiple passes.

FIG. 3 shows, schematically, a cross-sectional view of a stage of a method in accordance with the invention. The stage shown corresponds to the stage shown in FIG. 2 except that, in accordance with the invention, the compartments 8a and 8b, which are nearest neighbors compartments, are not filled with fluid at the same time. At the times compartment 8a is filled with fluid, the region in its nearest neighbor compartment 8b is already formed. In this manner it is prevented that any compartments which share a portion of the dam structure contain a volume of fluid at a same time, and thus the merger of such volumes is effectively prevented.

Generalizing the method which prevents merger of volumes of fluid deposited in nearest-neighbor compartments, is, in accordance with the invention, a method in which the plurality of compartments is filled not in a single pass but in a plurality of distinct passes. The first pass of such plurality of passes comprises:
making, among the plurality of compartments, a selection of compartments such that none of the compartments within the selection is a nearest neighbor of another (step “b)”);
filling, using the wet deposition method, the compartments of the selection with volumes of a fluid from which a region of the layer is obtainable in a quantity which is larger than the volume of the corresponding compartment (step “c)”);
obtaining from the volumes of fluid contained in the compartments the corresponding region of the layer and/or reducing the volumes of fluid contained in the compartments to a volume less than the volume of the corresponding compartments (step “d)”);
Subsequent passes of such plurality of passes comprise:
if there exist, among the plurality of compartments, compartments which have not yet been selected, making, among the plurality of compartments, a selection of compartments including compartments which have not yet been selected, the selection being such that none of the compartments within the selection is a nearest neighbor of another (step “e)”);
filling, using the wet deposition method, the compartments of the selection with volumes of a fluid from which a region of the layer is obtainable in a quantity which is larger than the volume of the corresponding compartment (step “c)”);
obtaining from the volumes of fluid contained in the compartments the corresponding region of the layer and/or reducing the volumes of fluid contained in the compartments to a size less than the volume of the corresponding compartments (step “d)”);

If all compartments which at some time need filling have been filled in a particular pass the formation of the patterned layer is complete with the proviso that some compartments which have been filled in the last pass might still contain some fluid. Therefore, provided this condition is met, the method in accordance with the invention comprises the following step:
if there exists, among the plurality of compartments, a compartment which contains fluid, obtaining the corresponding region from the volume of fluid contained in such compartment.

Optionally, the method in accordance with the invention may contain the further step of removing the dam structure. Since the primary function of the dam strcuture is to check the fluid deposited in compartments the primary function is obsolete after the patterned layer is formed. Therefore, in principle the method in accordance with the invention may include a step of removing the dam structure after the patterned is formed. Whether or not this is appropriate depends on the particular application in which the patterned is used. For example, if the dam structure adversely affects the formation of subsequent layers, it may be appropriate to remove it. On the other hand, if the removal itself degrades the patterned layer, the substrate or the dam structure or if the dam strcuture has a further function in the manufacture or use of the product of which the patterned layer is a part, it may be appropriate not to remove the dam structure. Leaving the dam structure in position is in general preferable if the patterned layer is an organic patterned layer, in particular if the dam structure is a photoresist relief pattern.

The method in accordance with the invention may be suitably used to manufacture any patterned layer, provided the layer comprises regions which are mutually arranged mutually adjacent and spaced in accordance with a desired pattern. In particular the thickness of the layer, more specifically, the thickness of the regions may be in the range from about 1 mm to the thickness of a molecular monolayer or atom layer or, more particular, about 500 μm to 10 nm or 100 μm to 20 nm or 50 μm to 50 nm or 10 μm to 70 nm. A typical dimension of the region in the plane of the layer may vary for example from about 1 m to 0.1 μm or more particular 1 cm to 1 μm or more particular 1 mm to 1 μm or 500 μm to 10 μm.

The patterned layer, more particular any region thereof may be made of any material, organic or inorganic, metallic, semiconducting, ceramic or polymeric provided a fluid is available from which the layer or region is obtainable. The method is particularly suitable if the patterned layer is formed from polymeric material. Polymeric materials generally have a high viscosity. In order to obtain a fluid containing polymeric material which has a viscosity compatible which conventional printing methods such as ink jet printing very dilute fluids need to be used. Accordingly, to obtain a relatively thick polymeric patterned layer, a lot of fluid is needed and consequently the risk of merger of volumes contained in nearest neighbor compartments is particularly large.

The regions of the patterned layer may all be formed of the same material of different regions may be formed of a different material. The method may be used to provide a layer which is homogeneous in terms of composition, that is a patterned layer of which the plurality of regions are all made of the same material. However, the method is particularly suitable for patterned layers comprising regions which are formed from different materials providing regions having different properties such as different optical, electrical, electro-optical or magnetic properties.

Regions need not have the same thickness. The pattern in which the layer is laid out may have any shape, irregular or regular.

The substrate surface may be any surface capable of supporting the patterned layer, dam structure and fluid. The substrate may be flat, or may have a relief structure it may have been provided with one or more (patterned) layers adapted to cooperate with the patterned layer during use of the product of which the patterned layer and the one or more layers are part. The substrate may be flexible or rigid, impervious to oxygen and/or transparent or opaque and may be made of any suitable material such as organic material more particular a polymeric material or inorganic material. Examples include paper, textile, metal, silicon, ceramic, in particular glass.

Optionally, after having formed the patterned layer, the patterned layer may be released from the substrate or transferred to another substrate if so desired.

The dam structure may be any structure which is suitable for checking the volume of fluid contained in a compartment. In order to obtain, from the volumes of liquid, regions which are uniform in thickness, the shape and material of the dam structure should be selected in accordance with the fluid and the quantity of the fluid to be deposited. The quantity of fluid deposited in the compartment exceeds the volume of the compartment which is possible without flooding the compartment if the interaction of between fluid, substrate surface and dam structure is mainly determined by surface tension (and thus wettability is a relevant parameter in region formation) as opposed to gravity.

A particular embodiment of a dam structure is a molecular monolayer. Such molecular monolayers (chemisorbed or physisorbed) and methods to deposit such monolayers in accordance with a desired pattern are well known as such, examples being monolayers formed of alkylthiols and alkylcarboxylates or in general phase transfer compounds. Langmuir Blodgett methods are particularly suitable to obtain such monolayers. Depending on the required wettability of the fluid with respect to the monolayer, the side of the molecular monolayer which is exposed to the fluid may be hydrophilic or hydrophobic and is opposite to the polarity of the substrate. Dam structures of monolayers have the advantage of being low in height and relatively easy to remove after the regions have been removed without damaging the regions.

Alternatively, the dam structure may be a relief pattern. Such patterns may of advantage when a large quantity of fluid is to be contained. Although the relief pattern may be formed of any suitable material which does not degrade when brought in contact with the fluid, for example inorganic material such as a metal, a ceramic material, oxidic material, glass and the like, preferable a photoresist pattern is used as a photoresist pattern is easy to manufacture.

The tranverse profile of the relief pattern dam structure may have any suitable shape such as rectangular, positively-sloped (that is top narrower than base) negatively-sloped (that is top broader than base) or rounded, mushroom-shaped and the like.

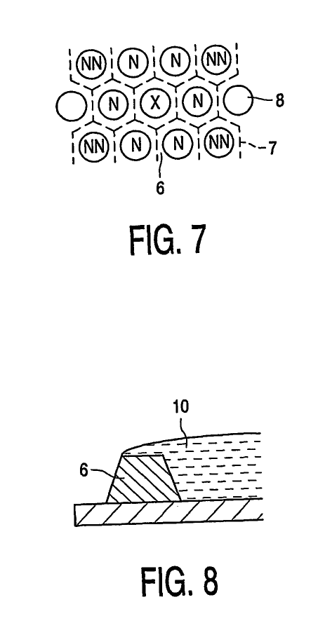

The surface of the relief pattern dam structure may be subjected to a treatment which modifies the wettability of the dam structure with respect to the fluid. Such treatments which are well known in the art include treatment with wetting agents, exposure to a CF₄ plasma or (UV) ozone. In general in order to maximize the capacity of a compartment it is advantageous to have a good wetting between fluid and dam structure. FIG. 8 shows a dam structure fluid combination having such a good wettability. In particular, the volume fluid 10 covers the entire top of the dam structure 6.

The height of a suitable dam structure is typically between 1 and 10 μm or 2 and 5 μm. The width of a dam structure section is determined by the application, but is typically about 2 μm to 50 μm.

The pattern in which the dam structure is provided is obviously first of all determined by the desired pattern of the patterned layer, as regions can only form in substrate regions which are exposed by the dam structure. Suitable dam structure patterns include rectangular and hexagonal patterns or a uniform layer in which cylindrical (for example circular cylindrical or frasto-conical) compartments are cut out. The method is particularly suitable if the dam structure comprises a plurality of strips which are arranged mutually parallel and spaced on the substrate. Using such a dam structure allows all compartments to be filled with fluid in a minimum number of passes, because each compartment has at most two nearest neighbors.

The selection among the plurality of compartments which are to be filled in a single pass is to be such that no compartment is selected which is a nearest neighbor of another selected compartment. In a broad sense, a compartment is a nearest neighbor of another if the compartments are filled with fluid to their full capacity and a merger of the volumes of fluid occurs. Typically, a compartment is a nearest neigbor of another if such compartment shares a section of the dam structure with that other. FIGS. 5 through 7 provide several examples of dam structures.

FIG. 5 shows, schematically, in a top view, a pattern of a first dam structure. The dam structure shown in FIG. 5 comprises a plurality of strips 6 which run in parrallel partitioning the substrate in longitudinal compartments 8. Each compartment labeled N is a nearest-neigbor of a compartment X. None of the compartments 10 labeled X share with each other a section of the dam structure 6 and are thus not nearest-neighbor of each other. The same applies for the compartments labeled N. Therefore, the set of compartments labeled X or a subset thereof can be safely selected in a single pass. No merging of volumes of fluid is expected. The same applies for the set of compartments labeled N, so all the compartments can be filled in two passes.

FIG. 6 shows, schematically, in a top view, a pattern of a second dam structure. The dam structure 6 has a reactangular pattern defining a plurality of rectangular compartments 8. The compartments labeled N share a dam structure section with the compartment labeled X, are thus nearest-neighbors, and accordingly the N compartments should not be in the same selection as X. If the fluid wets the dam structure extremely well there is a risk that merging of volumes of fluid deposited in the compartments labeled NN and X occurs because compartments X and NN are share a small portion of the dam structure. In that case the NN compartments are also considered nearest-neighbors of X and accordingly should not be in the same selection.

FIG. 7 shows, schematically, in a top view, a pattern of a third dam structure. The dam structure of FIG. 7 is comprised of a continuous layer in which circular regions have been cut out, the circular regions being laid out on a hexagonal grid. The compartment X has six nearest-neighbor compartments labeled N in extreme cases also including the compartents labeled NN.

Filling the compartments may be performed using any suitable wet deposition method which is capable of individually filling the compartments with fluid such as transfer, silk screen or off screen printing methods. For high resolution, dispensing and in particular ink jet printing is a preferred method, in particular a single nozzle or multi-nozzle method.

The fluid from which a region of the patterned layer is obtainable may be applied in any suitable form such as a liquid, a gel, an ink, a paste, a solution, an emulsion, a suspension of particles, in particular nanoparticles, a sol or a dispersion, the exact formulation being dependent on the wet deposition method used.

The method in accordance with the invention is particularly suitable if used with a fluid comprising a solvent which evaporates slowly. Slow evaporating solvents (typically such solvents have a high boiling point) extend the lifetime of the ink jethead by reducing the risk of blockage. If such solvent is used method in accordance with the invention, the fluid is allowed more time to dry and a more slowly evaporating solvent can be used if desired while still obtaining a uniform patterned layer.

The volume of fluid from which a region of the patterned layer is to be obtainable may contain the material the region is formed of as such or a precursor material thereof.

Typically, the fluid contains a solvent which is evaporated at the time a volume of fluid is converted into the corresponding region. The fluid to be deposited may contain further substances. For example, substances which modulate its rheological properties such as viscosity, (visco)elasticity, contact angle and/or wettability. Wetting agents, leveling agents, surfactants, thickening agents, diluents and the like may be added.

The quantity of fluid to be deposited in a compartment should exceed the volume of such compartment but be less than its capacity if flooding is to be prevented.

In a preferred embodiment of the method in accordance with the invention a compartment is filled with a quantity of fluid sufficient to wet more than half the surface area of the dam structure section shared between the said compartment and a nearest-neighbor compartment of the said compartment. In this preferred method the invention is exploited more fully because if in a prior art method nearest neighbor compartments would be filled with such an amount of fluid, merger of nearest-neighbor volumes would surely occur as each volume would claim more than half the surface area of the shared dam structure section. The larger volume allows thicker layers to be deposited within a single pass, or equivalently allows the dam structure to be made lower, if a same layer thickness is to be achieved.

To determine whether or not more than half the surface area of the shared dam structure is occupied by a volume of fluid, the dam structure is partitioned such that each location of the dam structure surface is assigned to the compartment closest to it. Some locations on the dam structure surface will be equidistant to two (or more) compartments. This set of equidistant locations defines unequivocally the boundaries between compartments. In FIGS. 5, 6 and 7 the compartment boundaries are indicated by the interrupted lines 7. If a volume of fluid deposited in a compartment crosses a compartment boundary with one of its nearest neighbors more than half the surface area of the dam structure section shared between that comparment and that nearest neighbor is considered to have been covered.

In order to reduce the risk of flooding due to process variations a compartment should not be filled to its fall capacity but only to about 95% thereof

After the compartments within the selection have been filled, the regions corresponding to the volumes contained in the compartments are to obtained. The obtaining may involve exposing, if required in an inert atmosphere, the volumes of fluid to increased or reduced temperatures, increased or reduced pressure, and/or radiation. Preferably, the obtaining is performed at an elevated temperature.

If the material of which a region is formed is present as such in the corresponding volume of fluid, it may be sufficient to evaporate the solvent and/or other volatile components. If the volume of contains a precursor material the obtaining also involves a chemical reaction. The wealth of chemical reactions known to those skilled in the art of chemistry may be exploited to derive suitable precursor materials. A preferred precursor material contains leaving groups which are eliminated during the conversion. An example is the conversion of a poly-p-phenylenevinylene in which at least part of the vinylene groups is replaced with ethanediyl groups carrying a leaving group such as an alkoxy, halogen or a sulfonium group. When thermally converted, the leaving group is eliminated and a vinylene group is formed.

It is not necessary to go all the way in obtaining the region from the volume of fluid. It is sufficient if a volume of fluid is reduced in volume to the extent that merging is no longer likely. In theory, merging of nearest neighbor volumes of fluid do not occur if neither of the said volumes covers more than half the surface of the shared dam strcuture, but to guard against occasional mergers due to statistical fluctuations in the method of manufacture, the volume is preferably reduced to less than the volume of the compartment. Only reducing the volume instead of going all the way makes the method faster

The method in accordance with the invention may be used in the manufacture of any suitable product or article, such as an article provided with a print or graphics, the print or graphics being provided in the form of a patterned layer manufactured in accordance with the method of the present invention. The patterned layers may be devices such as electronic, lighting and optical devices in which the patterned layer is not a decorative layer but a functional layer. The method may be of particular use in the manufacture of integrated circuits such polymer-based integrated circuits. The method is particularly suitable for the manufacture of displays, such as cathode ray tubes, plasma display panels, electrophoretic, filed emission and liquid crystal displays. In liquid crystal displays the color filter may be manufactured using the method in accordance with the invention.

The method is of particular use in the manufacture of an electroluminescent device, such as an organic or more specific a polymer electroluminescent device. Such a device is thin film device which typically includes several patterned layers such as an electroluminescent layer, hole transport and electron transport layer(s), electrode layer(s), barrier layer(s) and the like. Each of these layers is typically provided in accordance with a pattern to, for example, obtain a display having a individually addressable picture elements (pixels) well known examples of which include segmented displays and passive and active matrix displays. Accordingly, each of said patterned layers, in particular the patterned electroluminescent layer and the patterned transport layers are provided using the method in accordance with the invention.

### EXAMPLE NOT IN ACCORDANCE WITH THE INVENTION

By way of example, a patterned layer on a substrate surface as shown in FIG. 1 is manufactured by providing a glass substrate surface in a conventional manner with 270 μm wide indium tin oxide (ITO) tracks. A layer of a conventional HPR photoresist is then applied and processed using mask exposure to provide the substrate surface with a dam structure consisting of parallel strips which are each 5.7 μm high and 40 μm wide and spaced 300 μm apart to cover those parts of the substrate surface which are not covered by the ITO tracks, the dam structure and ITO tracks forming 300 μm wide elongated compartments for containing a volume of fluid from which a region of the patterned layer is obtainable. The substrate provided with dam structure looks like FIG. 5. The dams have a truncated circular shape to increase the wettability of the ITO tracks with respect to the fluid to be deposited, the substrate so obtained is subjected to a UV ozone treatment for 10 minutes.

An inkjet printer equipped with a piezo-electric single nozzle inkjet-head, nozzle diameter 50 μm, supplied by Microdrop, is charged with a water-based mixture of the polymers polyethylenedioxythiophene (PEDOT) and polystyrenesulphonic acid (PSS) supplied by Bayer AG, solid content 3.8% by weight.

With the ink-jet head positioned over a compartment, that compartment is filled by moving the ink-jet head relative to the substrate along the compartment with a speed such that the droplets of 165 pl (corresponds to a drop diameter of about 68 μm) produced by the inkjet head land 40 μm apart in the compartment. In the same manner all the other compartments are filled with fluid including the nearest-neighbor compartments of each compartment.

The volumes of fluid thus deposited in the compartments are then converted into corresponding regions of the polyethylenedioxythiophene—polystyrenesulphonic acid mixture to obtain the patterned layer. Given the amount of polymeric material in the fluid the thickness of the patterned layer is expected to be 550 μm. The resulting patterned layer is then examined under a microscope. A top view of the microscopic image observed is shown FIG. 4. The dark vertical lines in FIG. 4 correspond to the photoresist strips. FIG. 4 further clearly shows light and dark(er) regions which extend across many compartments and along a substantial part of the compartments. The light and dark(er) regions correspond to interference fringes. As is well known, interference fringes are caused by variations of thickness which are of the order of a quarter of the wavelength of the light used for illuminating the patterned layer. Since visible light is used (wavelength 400 to 600 μm) it is clear that the thickness of the regions, both within regions and between regions, is very non-uniform.

In order to demonstrate that the non-uniformity is related to the quantity of fluid deposited in each of the compartments the example is repeated with the sole difference that the speed of the ink jet head relative to the substrate is selected such that the droplets land further apart, more specifically 65 μm apart, thus filling the compartments with less fluid. Examining the patterned layer thus obtained under the microscope shows that no interference fringes are observed, indicating that the regions of the patterned layer have a uniform thickness.

Further investigations show that at a drop distance of 40 μm the compartment is filled with a quantity of fluid sufficient to wet more than half the surface area of the dam structure section shared between the said compartment and a nearest-neighbor compartment of the said compartment. In contrast, at a drop distance of 65 μm a compartment is filled with a quantity of fluid which is not sufficient to wet more than half the surface area of the dam structure section shared between the said compartment and a nearest-neighbor compartment of the said compartment. The contact angle between the PEDOT-containing fluid and the dam structure is about 10°.

### EXAMPLE IN ACCORDANCE WITH THE INVENTION

The previous example with the distance between droplets of 40 μm is repeated with the sole difference that the ink jet printing is, in accordance with the invention, performed in two passes. In the first pass the compartments labeled X (FIG. 5) are filled with volumes of fluid and then the corresponding regions are obtained by evaporating the water. In the second pass the compartments labeled N are filled and the regions corresponding to these volumes obtained by evaporation of water.

When examined under a microscope, the image of the patterned layer shows no interference fringes indicating that the patterned layer has very good thickness uniformity. The thickness of the regions is about 550 nm.

The example demonstrates that the volume of fluid which can be deposited in a compartment can be increased if the filling of the compartments is done is separate passes making sure that in each pass no nearest-neighbor compartments are filled. Hence, the method in accordance with the invention allows patterned layers to be formed which are thicker yet still have a uniform thickness.

A similar result, that is a relative thick layer having a good thickness uniformity, is obtained if the droplet distance is decreased to 20 μm illustrating that the quantity of fluid which can be deposited in a compartment can be at least a factor of three larger if the compartments are filled using the method in accordance with the invention as oposed to a prior art method in which all compartments at the same time.

The method is not only suitable for water-based fluids, but also organic solvent based fluids can be used. For example, similar results have been obtained for the deposition of patterned layers of light-emitting polymers such as poly-phenylenvinylenes, polyfluorenes and light emitting polymers containing a spiro unit, such polymers being as such well known in the art.

In summary, a method of manufacturing a patterned layer on a substrate comprises providing a substrate surface with a dam structure partitioning the substrate surface into a plurality of compartments for containing fluid from which regions of the patterned layer are obtainable, filling, using a wet deposition method, compartments with volumes of fluid and then obtaining from the volumes of fluid regions of the patterned layer.. In order to obtain a patterned layer which has a relatively large thickness and a good uniformity in thickness, the filling and obtaining is done in several passes, each pass comprising filling a selection of compartments with fluid having a volume larger than the volume of the compartment and obtaining the corresponding regions therefrom, taking care that in no selection two compartments which are nearest-neighbor of each other are included.

1. A method of providing, using a wet deposition method, a substrate surface with a patterned layer comprising a plurality of regions arranged mutually adjacent and spaced in accordance with a desired pattern, the method comprising:
providing a substrate surface with a dam structure in accordance with a pattern partitioning the substrate surface into a plurality of substrate regions to be covered by regions of the layer, the plurality of substrate regions and the dam structure together forming a plurality of compartments for containing volumes of fluid from which the plurality of regions is obtainable; making, among the plurality of compartments, a selection of compartments such that none of the compartments within the selection is a nearest neighbor of another compartment within the selection;
filling, using the wet deposition method, each of the compartments of the selection with a volume of a fluid from which a region of the layer is obtainable in a quantity which is larger than the volume of the corresponding compartment;
obtaining from the volumes of fluid contained in the compartments the corresponding region of the layer and/or reducing the volumes of fluid contained in the compartments to a volume less than the volume of the corresponding compartments;
if there exist, among the plurality of compartments, compartments which have not yet been selected, making, among the plurality of compartments, a selection of compartments including compartments which have not yet been selected, the selection being such that none of the compartments within the selection is a nearest neighbor of another and then going back to step c);
if there exists, among the plurality of compartments, a compartment which contains fluid, obtaining the corresponding region from the volume of fluid contained in such compartment.

2. A method as claimed in claim 1 including a step of removing the dam structure after completing the formation of the patterned layer.

3. A method as claimed in claim 1, wherein the patterned layer comprises regions which are formed from different materials.

4. A method as claimed in claim 1, wherein regions of the patterned layer are formed from polymeric material.

5. A method as claimed in claim 1, wherein the dam structure is a molecular monolayer.

6. A method as claimed in claim 1, wherein the dam structure is a relief pattern, preferably a photoresist relief pattern.

7. A method as claimed in claim 1, wherein the dam structure comprises a plurality of mutually parallel arranged strips.

8. A method as claimed in claim 1, wherein the filling of the compartments of the selection is performed using an ink jet printing method.

9. A method as claimed in claim 8, wherein the ink jet printing method is a single nozzle or a multi-nozzle ink jet printing method.

10. A method as claimed in as claimed in claim 1, wherein a compartment is filled with a quantity of fluid sufficient to wet more than half the surface area of the dam structure section shared between the said compartment and a nearest-neighbor compartment of the said compartment.

11. A method of manufacturing an electroluminescent device comprising a method as claimed in claim 1.
